(19) United States
(12) Patent Application Publication
(10) Pub. No.: US 2009/0116422 A1
(43) Pub. Date: May 7, 2009

(54) METHOD AND SYSTEM FOR OPPORTUNISTIC HYBRID RELAY SELECTION SCHEME FOR DOWNLINK TRANSMISSION

(76) Inventors: Chia-Chin Chong, Santa Clara, CA (US); Fujio Watanabe, Union City, CA (US); Hiroshi Inamura, Cupertino, CA (US)

Correspondence Address: Haynes and Boone, LLP;IP Section, 2323 Victory Avenue, SUITE 700, Dallas, TX, 75219, US

(21) Appl. No.: 12/257,334

(22) Filed: Oct. 23, 2008

Related U.S. Application Data
(60) Provisional application No. 60/985,175, filed on Nov. 2, 2007.

(51) Int. Cl. H04B 7/14

(52) U.S. Cl. 370/315

(57) ABSTRACT

An opportunistic hybrid-relay selection scheme for downlink transmission selects between cooperative relay and single relay schemes based on the channel conditions (e.g., signal-to-noise-ratio (SNR)) between the base station (BS) and RSs (i.e., BS-RSs link) and RSs and mobile station (MS) (i.e., RSs-MS link), respectively. In another selection scheme, a selection between the single relay (e.g., best-relay) transmission scheme or the cooperative-relay transmission scheme may be determined based on transmission paths (e.g., line-of-sight, obstructed-light-of-sight, non-light-of-sight) and channel conditions (e.g., SNR) between the BS-RSs link and the RSs-MS link, respectively.

### CROSS REFERENCE TO RELATED APPLICATIONS

The present application relates to and claims priority of U.S. provisional application (“Copending Provisional Application”), Ser. No. 60/985,175, entitled “Method and System for Opportunistic Hybrid Relay Selection Scheme for Downlink Transmission,” by C. Chong et al., filed on Nov. 2, 2007.

The present application is also related to U.S. provisional patent applications, (a) Ser. No. 60/947,153, entitled “Method and System for Reliable Relay-Associated Transmission Scheme” (“Wang I”), naming as inventors D. Wang, C. C. Chong, I. Guvenc and F. Watanabe, filed on Jun. 29, 2007; and (b) Ser. No. 60/951,532, entitled “Method and System for Opportunistic Cooperative Transmission Scheme” (“Wang II”), naming as inventors D. Wang, C. C. Chong, I. Guvenc and F. Watanabe, filed on Jul. 24, 2007.

The present invention is also related to U.S. Patent Application (“Copending Non-provisional Application”), entitled “Method and System for Reliable Relay-Associated and Opportunistic Cooperative Transmission Schemes,” Ser. No. 12/130,807, filed on May 30, 2008.

The disclosures of the Copending Provisional Application, the Copending Non-Provisional Application, Wang I and Wang II are hereby incorporated by reference in their entireties.

### BACKGROUND OF THE INVENTION

1. Field of the Invention

The present invention relates to a data communication network supporting mobile devices. In particular, the present invention relates to reliable data transmission in such a data communication network using relay stations.

2. Discussion of the Related Art

In wireless data communication networks, relay selection algorithms and cooperative diversity protocols are implemented via distributed virtual antennas to improve reliability. Improved reliability is achieved by creating additional paths between a source (e.g., base station or “BS”) and a destination (e.g., a mobile station or “MS”) using intermediate relay nodes (“RSs”).

User cooperation provides transmission diversity for MSs. Protocols using user cooperation are disclosed, for example, in the articles (a) “User cooperation diversity. Part I: System description” (“Sendonaris I”), by A. Sendonaris, E. Erkip, and B. Aazhang, published in IEEE Trans. Commun., vol. 51, no. 11, pp. 1927-1938, November 2003; and (b) “User cooperation diversity. Part II: Implementation aspects and performance analysis” (“Sendonaris II”), by A. Sendonaris, E. Erkip, and B. Aazhang, published in IEEE Trans. Commun., vol. 51, no. 11, pp. 1939-1948, November 2003. Sendonaris I and II assume knowledge of the forward channel and describe a beamforming technique which requires the source and a relay node to adjust the phases of their respective transmissions, so that their transmissions can add coherently at the destination. However, such a method requires considerable modifications to existing radio-frequency front-ends, which increase both the complexity and cost of the transceivers.

The article “Distributed space-time-coded protocols for exploiting cooperative diversity in wireless networks” (“Laneman I”), by J. N. Laneman and G. W. Wornell, published in IEEE Trans. Inf. Theory, vol. 49, no. 10, pp. 2415-2425, October 2003, discloses relay and cooperative channels that allow the MSs to transmit and receive simultaneously (i.e., full-duplex). To exploit coherent transmission, Laneman I assumes that channel state information (CSI) is available at the transmitters (TXs). Furthermore, Laneman I focuses on ergodic settings and characterizes performance using Shannon capacity regions. A later article, “Cooperative diversity in wireless networks: Efficient protocols and outage behavior” (“Laneman II”), by J. N. Laneman, D. N. C. Tse, and G. W. Wornell, published in IEEE Trans. Inf. Theory, vol. 51, no. 12, pp. 3062-3080, December 2004, discloses lower complexity cooperative diversity protocols that employ half-duplex transmissions. In Laneman II, no CSI is assumed available at the TXs, although CSI is assumed available at the receivers (RXs). As a result, beamforming capability is not used in Laneman II. Laneman II focuses on non-ergodic or delay-constrained situations. At a given rate, cooperation with half-duplex operation (as discussed in Laneman II) requires twice the bandwidth as of direct transmission. The increased bandwidth leads to greater effective signal-to-noise-ratio (SNR) losses at higher spectral efficiency. Furthermore, depending on the application, additional receiver hardware may be required to allow the sources to relay for each other, especially in a cellular system using frequency-division duplexing.

The diversity-multiplexing tradeoff for cooperative diversity protocols with multiple relays was studied in both Sendonaris I and the article, “On the achievable diversity-vs-multiplexing tradeoff in cooperative channels” (“Azarian”), by K. Azarian, H. E. Gamal, and P. Schniter, and published in the IEEE Trans. Inf. Theory, vol. 51, pp. 4152-4172, December 2005. Sedonaris I discloses orthogonal transmission between source and relays, and Azarian discloses simultaneous transmissions in the source and the relays. In particular, Azarian involves a design of cooperative transmission protocols for delay-limited coherent fading channels, with each channel consisting of single-antenna, half-duplex nodes. Azarian shows that, by relaxing the orthogonality constraint, considerable performance improvement may be achieved because resources are used more efficiently (although incurring a higher complexity at the decoder).

The approaches of Sendonaris I and Azarian are information theoretic in nature, and the design of practical codes having the desired characteristics is left for further investigation. Practical code design is difficult and is a subject matter of active research, although space-time codes for the “real” multiple-input-multiple-output (MIMO) link (where the antennas belong to the same central terminal) are disclosed in “Lattice coding and decoding achieve the optimal diversity-multiplexing tradeoff of MIMO channels” (“Gamal”), by H. E. Gamal, G. Caire, and M. O. Damen, and published in IEEE Trans. Inf. Theory, vol. 50, no. 6, pp. 968-985, June 2004. According to Sendonaris I, how such codes may provide residual diversity without sacrificing achievable data rates is unclear. In other words, practical space-time codes for cooperative relay channels—where antennas belonging to different terminals are distributed in space—are fundamentally different from the space-time codes for “real” MIMO link channel.

The relay channel is fundamentally different from the “real” MIMO link because information is not known to the RSs a priori, but has to be communicated over noisy links. Moreover, the number of participating antennas is not fixed, but depends not only on the number of participating RSs, but the number of such RSs that can successfully relay the information transmitted from the source. For example, for a decode-and-forward relay, successful decoding must precede retransmission. For amplify-and-forward relays, a good received SNR is necessary. Otherwise, such relays forward mostly their own noise. See, e.g., “Fading relay channels: Performance limits and space-time signal design” (“Nabar”), by R. U. Nabar, H. Bolcskei, and F. W. Kneubuhler, published in IEEE J. Sel. Areas Commun., vol. 22, no. 6, pp. 1099-1109, June 2004. Therefore, the number of participating antennas in cooperative diversity schemes is in general random. Space-time coding schemes invented for a fixed number of antennas have to be appropriately modified.

The relay selection methods discussed in Sendonaris I and II, Laneman I and II, and Azarian all require distributed space-time coding algorithms, which are still unavailable for situations involving more than one RS. For example, relaying schemes, such as those disclosed in Sendonaris I, require an orthogonal transmission between the source and the relays. Such relaying schemes are usually difficult to maintain in practice.

Apart from practical space-time coding for the cooperative relay channel, the formation of virtual antenna arrays using individual RSs distributed in space requires significant amount of coordination. Specifically, forming cooperating groups of RSs involves distributed algorithms (see, e.g., Sendonaris I), while synchronization at the packet level is required among several different TXs. Those additional requirements for cooperative diversity demand significant modifications to many layers of the communication stack (up to the routing layer) that has been built according to conventional point-to-point, non-cooperative communication systems.

The article “Practical relay networks: A generalization of hybrid-ARQ” (“Zhao”) by B. Zhao and M. C. Valenti, published in IEEE J. Sel. Areas Commun., vol. 23, no. 1, pp. 7-18, January 2005, discloses an approach which involve multiple relays operating over orthogonal time slots, based on a generalization of the hybrid-automatic repeat request (HARQ) scheme. Unlike a conventional HARQ scheme, retransmitted packets need not be transmitted from the original source, but may be provided by relay nodes that overhear the transmission. The best relay may be selected based on its location relative to both the source and the destination. Because such a scheme requires knowledge of distances between all relays and the destination, a location determination mechanism (e.g., global positioning system (GPS)) is required at the destination to perform distance estimation. Alternatively, the destination may rely on a RX that can perform distance estimation using expected SNRs. For a mobile network, location estimation is necessarily repeated frequently, resulting in substantial overhead. Such a relaying scheme is therefore more appropriate for a static network than a mobile network. Relaying protocols such as Zhao's are truly cross-layer, involving mechanisms from both the medium access control (MAC) and the routing layers. Because more than one RS listens to each transmission, such relaying schemes are complex, so that an upper limit on the number of relays that should be used in any given situation is appropriate. Furthermore, the MAC protocol layer becomes more complicated, because it is required to support relay selection.

RS selection may be achieved by geographical routing, which is discussed in the article “Geographic random forwarding (GeRaF) for ad hoc and sensor networks: Multihop performance” (“Zorzi”), by M. Zorzi and R. R. Rao, published in IEEE Trans. Mobile Comput., vol. 2, no. 4, pp. 337-348, October-December 2003. Similar HARQ-based schemes are discussed in the articles (a) “Achievable diversity-multiplexing-delay tradeoff in half-duplex ARQ relay channels” (“Tabet”), by T. Tabet, S. Dusad and R. Knopp, published in Proc. IEEE Int. Sym. On Inf. Theory, Adelaide, Australia, pp. 1828-1832, September 2005; and (b) “Hybrid-ARQ in multihop networks with opportunistic relay selection” (“Lo”), by C. K. Lo, R. W. Heath, Jr. and S. Vishwanath, published in Proc. IEEE Int. Conf. on Acoustics, Speech, and Signal Proc., Honolulu, Hi., USA, April 2007. Tabet and Lo are applicable to delay-limited fading single relay channel.

U.S. Patent Application Publication 2006/0239222 A1, entitled “Method of providing cooperative diversity in a MIMO wireless network” (“Kim”), naming as inventors S. Kim and H. Kim, filed Oct. 26, 2006, discloses a method for providing cooperative diversity in a MIMO wireless network. In Kim, the RSs check for errors, relay the correct streams and request retransmission of error streams from the BS. Zhao, Tabet, Lo and Kim's methods all involve only one RS and thus do not benefit from cooperative diversity.

In most conventional cooperative diversity schemes, the BS retransmits packets, even when only one RS fails to receive the reliable packets. See, e.g., the article “An ARQ in 802.16j” (“Yoon”), by S. Jin, C. Yoon, Y. Kim, B. Kwak, K. Lee, A. Chindapol and Y. Saifullah, published in IEEE C802.16j-07/250r4, March 2007. Yoon's scheme may introduce latency or even a deadlock between the BS and RSs, as the number of RSs increases.

Other schemes select the “best RS” based on instantaneous channel conditions. See, e.g., the article “A simple distributed method for relay selection in cooperative diversity wireless networks based on reciprocity and channel measurements” (“Bletsas”), by A. Bletsas, A. Lippman, and D. P. Reed, published in Proc. IEEE Vech. Technol. Conf., vol. 3, Stockholm, Sweden, May 30-Jun. 1, 2005, pp. 1484-1488. Bletsas's scheme is very complex, especially in a fast-moving mobile environment. Furthermore, fast switching among RSs increases the workload and overhead of the central controller. Therefore, the selection of “best RS” based on instantaneous channel conditions is less appropriate for fast-moving mobile environments (e.g., outdoor environment) than for static or nomadic environments (e.g., indoor environment).

A threshold-based opportunistic cooperative ARQ transmission approach is disclosed in Wang I and II. In Wang I and II, transmission between the BS and the MS can be separated into two parts—i.e., between the BS and the RSs (the “BS-RSs link”) and between RSs and MS (the “RSs-MS link”). The messages for acknowledgement in Wang I and II are different from conventional acknowledgement or negative acknowledgment messages (ACK/NACK) used for unicast transmission. In particular, two new types of ARQ messages are introduced for multicast transmission. These ARQ messages are the relay associated ACK/NACK (i.e., R-ACK/R-NACK) for BS-RSs link, and the cooperative ACK/NACK (i.e., C-ACK/C-NACK) for the RSs-MS link. Here, a pre-defined threshold is applied to evaluate the reliability of the BS-RSs link. If the number of reliable RSs is larger than the threshold value, the reliable RSs transmit the packet to the MS in a cooperative manner.

Except for Tabet, the schemes discussed above ignore the situation in which an RS which does not receive reliable information from the BS may be able to overhear the transmission between the reliable RSs and the MSs. Tabet has the drawback of focusing on selecting one RS at each hop. Wang I and II do not discuss a criterion to set the threshold value that determines the number of reliable RSs.

The schemes in the prior art discussed above only considers either single-relay, conventional cooperative-relay or multicast cooperative-relay. None of the prior art schemes considers hybrid-relay based on channel conditions between the BS-RSs link and/or the RSs-MS link.

### SUMMARY

According to one embodiment of the present invention, an opportunistic hybrid-relay selection scheme for downlink transmission selects between cooperative relay and single relay schemes based on the channel conditions (e.g., signal-to-noise-ratio (SNR)) between the base station (BS) and RSs (i.e., BS-RSs link) and RSs and mobile station (MS) (i.e., RSs-MS link), respectively.

Alternatively, the selection between the single relay (e.g., best-relay) transmission scheme or the cooperative-relay transmission scheme may be determined based on transmission paths (e.g., line-of-sight, obstructed-light-of-sight, non-light-of-sight) and channel conditions (e.g., SNR) between the BS-RSs link and the RSs-MS link, respectively.

In one embodiment, the selection method is optimized either to an outage probability constraint or to a throughput constraint.

A scheme under the present invention trades-off overall overhead and latency inherent in relaying or cooperative communications techniques, while still offering a good outage probability and throughput performance.

The present invention is better understood upon consideration of the detailed description below, in conjunction with the accompanying drawings.

### BRIEF DESCRIPTION OF THE DRAWINGS

FIG. 1 illustrates a conventional direct downlink transmission scheme in a cellular network.

FIG. 2 illustrates a simple 2-hop single relay downlink transmission scheme.

FIG. 3 illustrates a multi-hop single relay downlink transmission scheme.

FIG. 4 illustrates a cooperative relay downlink transmission scheme.

FIG. 5 illustrates a cooperative relay transmission scheme described in the Copending Non-provisional Application incorporated by reference above.

FIG. 6 summarizes method 600 in which one of three relay selection schemes may be selected by the network during operation, in accordance with the present invention.

FIG. 7 illustrates providing alternative selection option 702 (“best relay”) or option 704 (“random relay”) in a single relay scheme, in accordance with one embodiment of the present invention.

FIG. 8 shows flowchart 800, which illustrates a hybrid relay selection scheme based on an outage probability constraint, according to one embodiment of the present invention.

FIG. 9 shows flowchart 900, which illustrates a hybrid relay selection scheme based on a throughput constraint, according to one embodiment of the present invention.

### DETAILED DESCRIPTION OF THE PREFERRED EMBODIMENTS

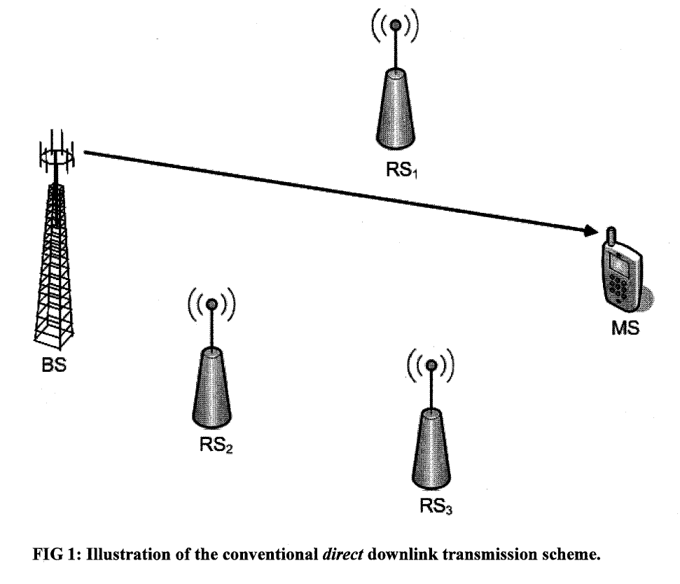

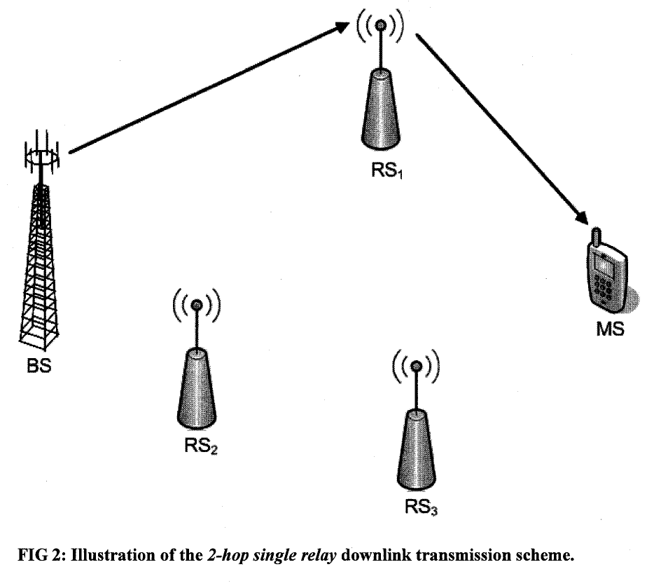

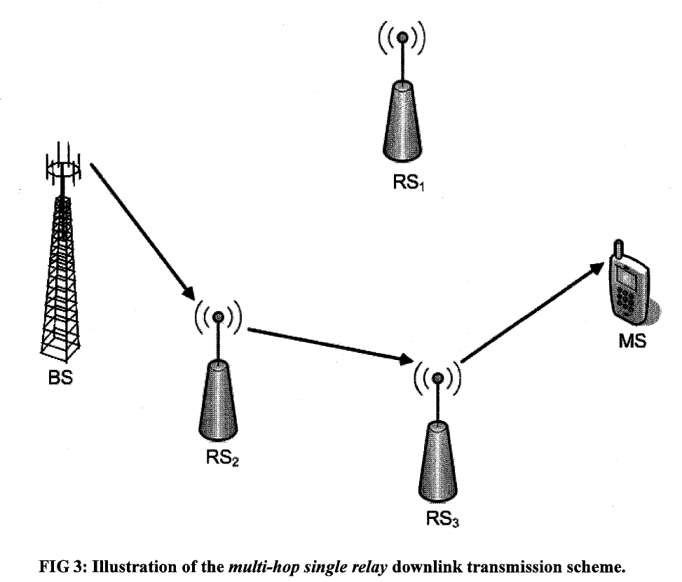

FIG. 1 illustrates a conventional direct downlink transmission scheme in a cellular network, in which a BS transmits a signal to an MS within the coverage area of the BS. Often, however, such a MS may be located in a coverage hole, or may be outside of the coverage area of the BS. If the MS is in a coverage hole or outside of the coverage area of the BS, one or more RSs may be used to carry out the desired transmission. FIG. 2 illustrates a simple 2-hop single relay downlink transmission scheme, using a single RS. FIG. 3 illustrates a multi-hop single relay downlink transmission scheme, using two or more RSs. These indirect transmission schemes are low-cost candidates that can provide the benefits of capacity enhancement and coverage extension.

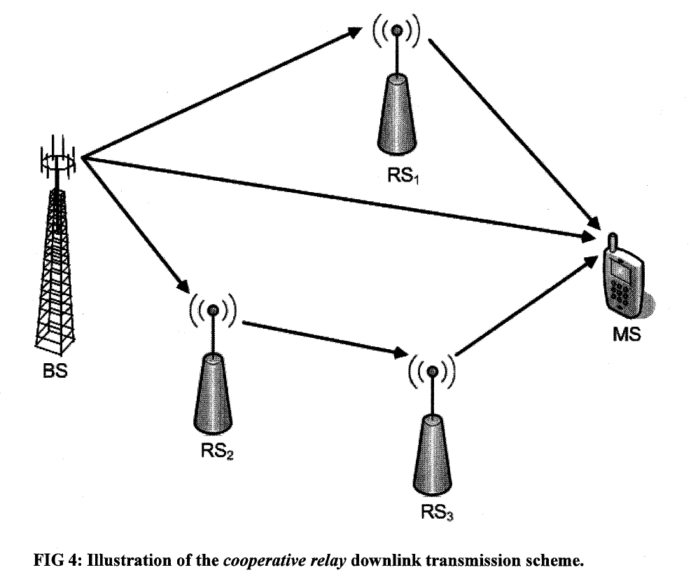

FIG. 4 illustrates a cooperative relay downlink transmission scheme, in which the desired transmission arrives at the MS over both direct and indirect transmission paths. Cooperative relay, also referred to as cooperative communication, is expected to provide the benefits of conventional MIMO schemes (e.g., spatial diversity gain), thereby obtaining higher throughput and reliability.

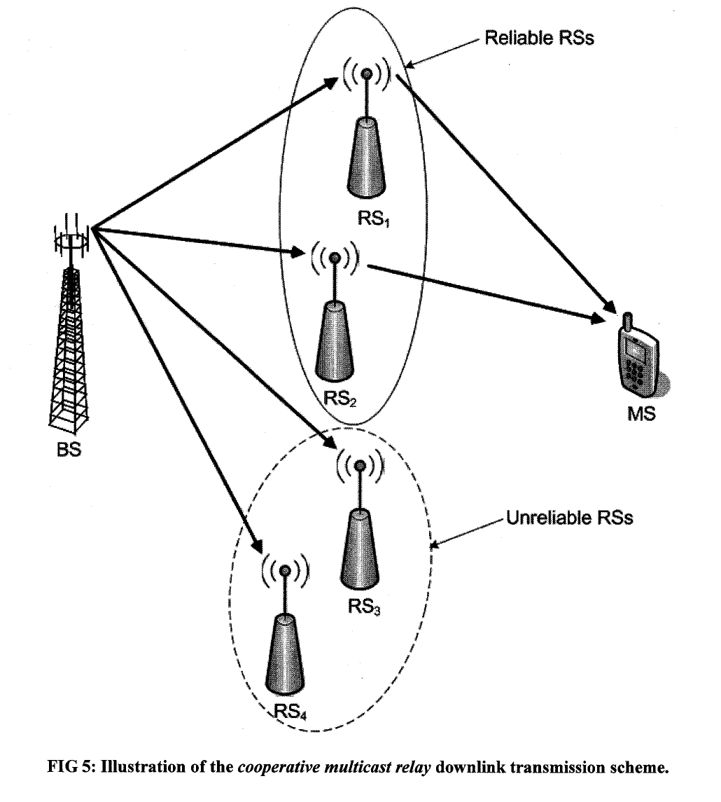

FIG. 5 illustrates a cooperative relay transmission scheme described in the Copending Non-provisional Application incorporated by reference above. Specifically, the scheme shown in FIG. 5 is referred to as a cooperative multicast relay transmission scheme. According to the cooperative multicast relay transmission scheme, transmission between the BS and the MS can be separated into two parts—i.e., between the BS and the RSs (the “BS-RSs link”) and between RSs and MS (the “RSs-MS link”). The channel conditions in these two parts are characterized by their respective SNRs. Here, a pre-defined threshold value allows evaluation of the reliability of the BS-RSs link. If the number of reliable RSs is larger than this threshold value, the reliable RSs transmit the packet to the MS in a cooperative manner. According to this scheme, only reliable RSs transmit packets to the MS, while unreliable RSs remain passive.

According to one embodiment of the present invention, a hybrid scheme is provided that combines more than one of the cooperative transmission schemes or with a single relay scheme. The hybrid scheme allows selecting a different relaying scheme under different transmission paths and channel conditions, so as to reduce both latency in the cellular network and the processing burden of the BS. In one hybrid relay selection scheme of the present invention, the type of relaying scheme is selected depending on the environment, transmission paths (e.g., line-of-sight (LOS), obstructed-LOS (OLOS), non-LOS (NLOS)), channel conditions, and channel qualities (e.g., SNR¹) of both the BS-RSs link (i.e., SNR₁) and the RSs-MS link (i.e., SNR₂). ¹In general, SNR can be “instantaneous SNR”, “small-scale average SNR” (i.e., average SNR over slow-fading/shadowing) or “average SNR”.

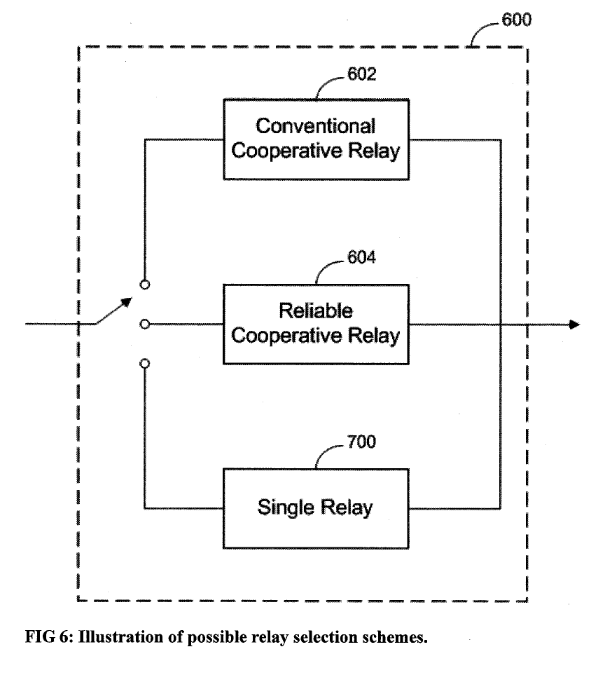

FIG. 6 summarizes method 600 in which one of three relay selection schemes may be selected by the network during operation, in accordance with the present invention. As shown in FIG. 6, option 602 provides a conventional cooperative relay scheme, in which all RSs within the network may participate in cooperatively relaying the information from a BS to MS. One example of a conventional cooperative relay scheme is illustrated in FIG. 4.

Alternatively, option 604 represents a reliable cooperative relay scheme, in which only RSs within a reliable multicast grouping (i.e., the RSs found in a initial or periodical ranging process to be reliably receiving data packets from the BS) may participate in either forwarding or cooperatively relaying data packets from the BS to the MS. One example of a reliable cooperative relay scheme is illustrated in FIG. 5. In one embodiment, a threshold value v controls the minimum number of RSs that can form a reliable multicast group. Forwarding by a single reliable RS is indicated when threshold value v is assigned v=1, and cooperative relaying is indicated when threshold value v is assigned v>1. Details regarding an example of value assignments of threshold value v are provided in a copending U.S. patent application (the “PA-617 application”), Ser. No. ______, entitled “Method and System of Threshold Selection for Reliable Relay Stations Grouping for Downlink Transmission,” naming C. Chong et al. as inventors, filed on the same day as the present invention, and which is hereby incorporated by reference in its entirety.

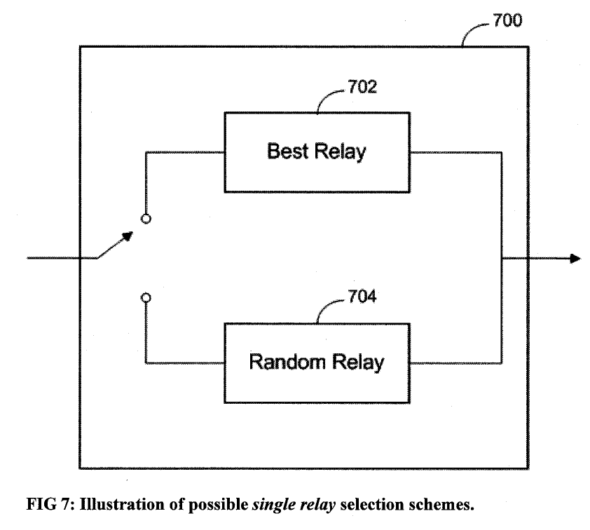

Option 700 represents a single relay scheme in which only one RS forwards data packets from the BS to the MS, or from an RS to another RS. One example of a single relay scheme which forwards data packets from the BS to the MS is illustrated in FIG. 2 above. One example of a single relay scheme in which data packets are forwarded from one RS to another RS is illustrated in FIG. 3. This single RS may be selected as the best relay under methods described, for example, in Bletsas (discussed above) or in U.S. provisional patent application (the “'332 provisional application”), Ser. No. 60/871,332, entitled “Method and System for Simple Relay Selection Based on Slow-Fading Channel Conditions,” naming C. Chong et al. as inventors, filed on Dec. 21, 2006. The single relay in the single relay scheme may also be selected randomly as random relay. FIG. 7 illustrates providing alternative selection option 702 (“best relay”) or option 704 (“random relay”) in a single relay scheme, in accordance with one embodiment of the present invention.

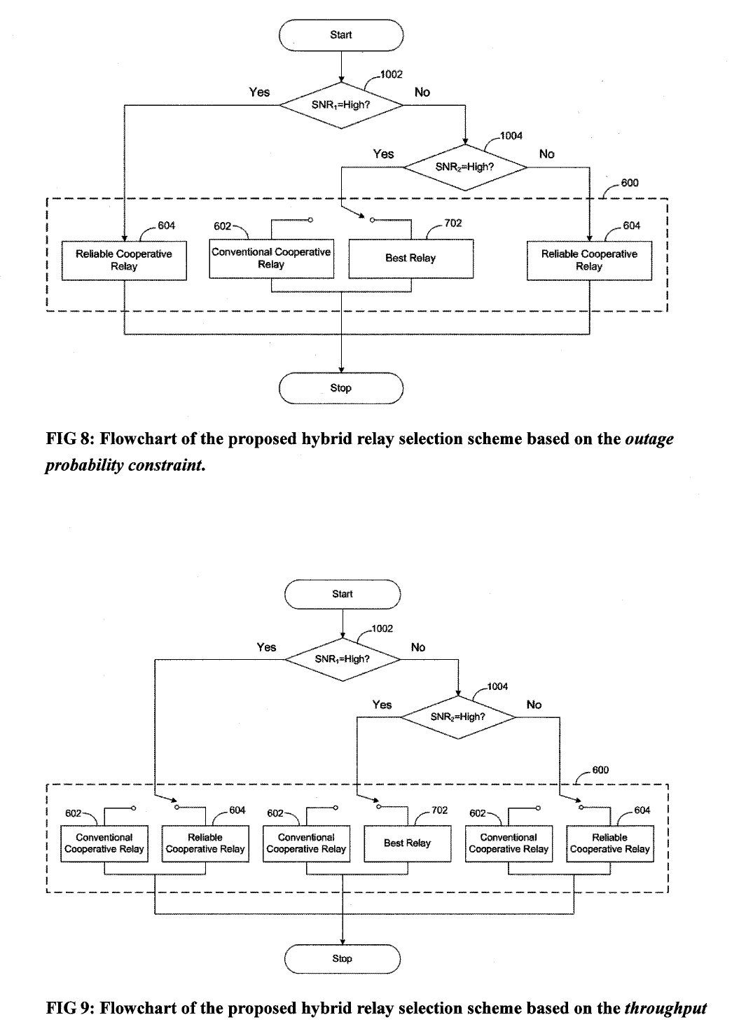

In the PA-617 application, incorporated by reference above, an outage probability refers to the probability for losing a packet and throughput refers to the average number of correctly received packets per transmission. FIG. 8 shows flowchart 800, which illustrates a hybrid relay selection scheme based on an outage probability constraint, according to one embodiment of the present invention. As shown in FIG. 8, at step 1002, when the signal condition at the BS-RSs link is strong (e.g., a high SNR₁ ), a reliable cooperative relay scheme is selected to increase the cooperative diversity gain in the RSs-MS link (option 604) and thus, to reduce the outage probability. However, at step 1002, when the signal condition at the BS-RSs link is weak (i.e., a low SNR₁), the signal condition at the RSs-MS link is examined (step 1004). When the signal condition at the RSs-MS link is strong (e.g., a high SNR₂), either a conventional cooperative relay scheme (option 602) or a best relay scheme (option 702) may be selected in order to provide a better outage performance (as compared to other relaying schemes). However, to reduce overhead inherent in cooperative relay techniques, one may choose the best relay scheme. The selection is typically carried out by a central controller of the cellular network (e.g., at the BS). When the signal condition at the RSs-MS is weak (i.e., a low SNR₂), a reliable cooperative relay scheme (option 604) is selected to ensure that at least one of the RSs within the reliable group provides an acceptable overall link with both BS and MS.

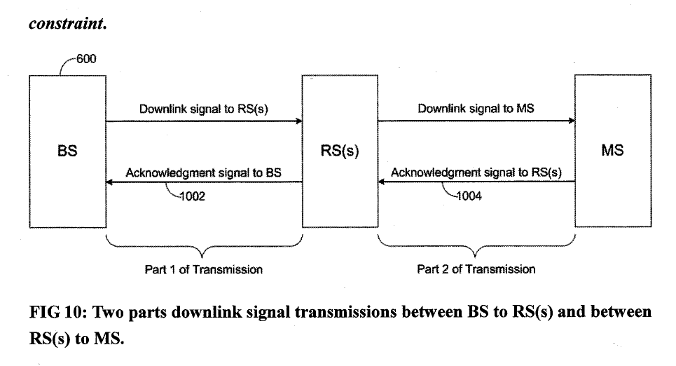

FIG. 9 shows flowchart 900, which illustrates a hybrid relay selection scheme based on a throughput constraint, according to one embodiment of the present invention. To optimize throughput performance, at step 1002, when the signal condition at the BS-RSs link is strong (e.g., a high SNR₁), a cooperative relaying scheme is selected to maximize diversity gain at the RSs-MS link. Suitable cooperative relaying scheme includes a conventional cooperative relaying scheme (e.g., option 602) or a reliable cooperative relaying scheme (e.g., option 604). However, at step 1002, when the BS-RSs link is weak (e.g., a low SNR₁), the RSs-MS link is examined. Therefore, at step 1004, when the signal condition at the RSs-MS link is strong (e.g., a high SNR₂), either a conventional cooperative relay scheme (option 602) or a best relay scheme (option 702) may be selected, with a preference for a best relay scheme to reduce overhead. However, if the signal condition at the RSs-MS link is weak (e.g., a low SNR₂), either a conventional cooperative relaying scheme (option 602) or a reliable cooperative relaying scheme (option 604) is selected to maximize overall diversity gain.

FIG. 10 shows a transmissions and message exchange protocol used in the two-part downlink signal transmission over the BS-RSs link and RSs-MS link, in accordance with the present invention. As shown in FIG. 10, the SNR of the BS-RSs link (i.e., SNR₁) can be fed back to BS via an acknowledgment signal (1002) or another form of message exchange from the RSs. Based on this feed back, the BS can adjust SNR₁ by changing its transmission power. Similarly, the SNR of RSs-MS link (i.e., SNR₂) can be fed back to the RSs by an acknowledgment signal (1004) or another form of message exchange from the MS. This acknowledgment signal may be provided, for example, during the initial and periodical ranging processes for forming a relay-associated group of RSs (“R-group”), such as that described in the Copending Non-provisional Application incorporated by reference above.

A method according to the present invention has a significant advantage over the prior art because of its flexibility and capability in having a hybrid relay selection scheme based on channel conditions to form a reliable group of RSs under a cooperative multicast relay transmission scheme. A method of the present invention enables a cellular network to optimize its performance by controlling a threshold value that is based on outage probability or throughput.

The above detailed description is provided to illustrate specific embodiments of the present invention and is not intended to be limiting. Numerous modifications and variations within the scope of the present invention are possible. The present invention is set forth in the following claims.

We claim:

1. A method for selecting a data relay scheme through a relay station, comprising:
evaluating a first signal condition between a transmitter and one or more relay stations; and
selecting a reliable cooperative relay scheme, when the first signal condition is stronger than a first predetermined value; otherwise:
evaluating a second signal condition between the one or more relay stations and a destination, and
selecting one of (a) a cooperative relay scheme, other than a reliable cooperative relay scheme, and (b) a single relay scheme, when the second signal condition is stronger than a second predetermined value, and selecting a reliable cooperative relay scheme, otherwise.

2. A method as in claim 1, wherein the single relay scheme comprises one of (a) a random relay scheme, and (b) a best relay scheme.

3. A method as in claim 1, wherein the first and second signal conditions are determined based on whether or not a line-of-sight condition, a non-line-of-sight condition or an obstructed-line-of-sight condition exists.

4. A method as in claim 1, wherein the first and second signal conditions are evaluated based on a signal-to-noise ratio.

5. A method as in claim 1, wherein the method reduces a probability of a lost packet.

6. A method for selecting a threshold value for determining a reliable relay station group, under a cooperative relay transmission scheme, comprising:
evaluating a first signal condition between a transmitter and one or more relay stations; and
selecting a cooperative relay scheme, when the first signal condition is stronger than a first predetermined value; otherwise:
evaluating a second signal condition between the one or more relay stations and a destination, and
selecting one of (a) a cooperative relay scheme, other than a reliable cooperative relay scheme, and (b) a best relay scheme, when the second signal condition is stronger than a second predetermined value, and selecting a cooperative relay scheme, otherwise.

7. A method as in claim 6, wherein the single relay scheme comprises one of (a) a random relay scheme, and (b) a best relay scheme.

8. A method as in claim 6, wherein the first and second signal conditions are determined based on whether or not a line-of-sight condition, a non-line-of-sight condition or an obstructed-line-of-sight condition exists.

9. A method as in claim 6, wherein the first and second signal conditions are evaluated based on a signal-to-noise ratio.

10. A method as in claim 6, wherein the method results in increasing an average number of correctly received packets per transmission.

11. A two-part transmission system to a destination, comprising:
a transmitter; and
a plurality of relay stations, wherein the transmitter transmit a data packet to a subset of the relay stations, which forward the data packet to the destination and wherein the transmission is carried out according to a method comprises:
evaluating a first signal condition between a transmitter and one or more relay stations; and
selecting a reliable cooperative relay scheme, when the first signal condition is stronger than a first predetermined value; otherwise:
evaluating a second signal condition between the one or more relay stations and a destination, and
selecting one of (a) a cooperative relay scheme, other than a reliable cooperative relay scheme, and (b) a best relay scheme, when the second signal condition is stronger than a second predetermined value, and selecting a reliable cooperative relay scheme, otherwise.

12. A two-part transmission system as in as in claim 11, wherein the single relay scheme comprises one of (a) a random relay scheme, and (b) a best relay scheme.

13. A two-part transmission system as in claim 11, wherein the first and second signal conditions are determined based on whether or not a line-of-sight condition, a non-line-of-sight condition or an obstructed-line-of-sight condition exists.

14. A two-part transmission system as in claim 11, wherein the first and second signal conditions are evaluated based on a signal-to-noise ratio.

15. A two-part transmission system as in claim 11, wherein the method reduces a probability of a lost packet.

16. A two-part transmission system to a destination, comprising:
a transmitter; and
a plurality of relay stations, wherein the transmitter transmit a data packet to a subset of the relay stations, which forward the data packet to the destination and wherein the transmission is carried out according to a method comprises:
evaluating a first signal condition between a transmitter and one or more relay stations; and
selecting a cooperative relay scheme, when the first signal condition is stronger than a first predetermined value; otherwise:
evaluating a second signal condition between the one or more relay stations and a destination, and
selecting one of (a) a cooperative relay scheme, other than a reliable cooperative relay scheme, and (b) a best relay scheme, when the second signal condition is stronger than a second predetermined value, and selecting a cooperative relay scheme, otherwise.

17. A two-part transmission system as in as in claim 16, wherein the single relay scheme comprises one of (a) a random relay scheme, and (b) a best relay scheme.

18. A two-part transmission system as in claim 16, wherein the first and second signal conditions are determined based on whether or not a line-of-sight condition, a non-line-of-sight condition or an obstructed-line-of-sight condition exists.

19. A two-part transmission system as in claim 16, wherein the first and second signal conditions are evaluated based on a signal-to-noise ratio.

20. A two-part transmission system as in claim 16, wherein the method results in increasing an average number of correctly received packets per transmission.
